(19) United States
(12) Patent Application Publication
(10) Pub. No.: US 2026/0230262 A1
(43) Pub. Date: Aug. 6, 2026

(54) CLUSTER INFORMATION LEARNING IN FREQUENCY DIVISION DUPLEX SYSTEMS

(71) Applicant: QUALCOMM Incorporated, San Diego, CA (US)

(72) Inventors: Vasanthan RAGHAVAN, West Windsor Township, NJ (US); Xiaoxia ZHANG, San Diego, CA (US); Junyi LI, Greentown, PA (US)

(21) Appl. No.: 19/044,464

(22) Filed: Feb. 3, 2025

(51) Int. Cl. H04L 5/00; H04L 5/14

(52) U.S. Cl. CPC H04L 5/0051; H04L 5/0044; H04L 5/14

(57) ABSTRACT

Certain aspects of the present disclosure provide techniques for wireless communications. An example method includes obtaining a reference signal configuration. In some cases, the reference signal configuration includes at least one downlink reference signal configuration and at least one uplink reference signal configuration. In some cases, one or more downlink reference signal transmissions associated with the at least one downlink reference signal configuration have a same periodicity as one or more uplink reference signal transmissions associated with the at least one uplink reference signal configuration. The method may also include outputting, for each channel cluster of one or more channel clusters, a set of channel cluster parameters. In some cases, the set of the channel cluster parameters are based at least in part on the one or more downlink reference signal transmissions.

### INTRODUCTION

### Field of the Disclosure

Aspects of the present disclosure relate to wireless communications, and more particularly, to techniques for cluster information learning in frequency division duplex (FDD) systems.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provide a method for wireless communications by a user equipment (UE). The method includes obtaining a reference signal configuration, wherein: the reference signal configuration comprises at least one downlink reference signal configuration and at least one uplink reference signal configuration, and one or more downlink reference signal transmissions associated with the at least one downlink reference signal configuration have a same periodicity as one or more uplink reference signal transmissions associated with the at least one uplink reference signal configuration; and outputting, for each channel cluster of one or more channel clusters, a set of channel cluster parameters, wherein the set of the channel cluster parameters are based at least in part on the one or more downlink reference signal transmissions.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating example cluster information learning performed between a UE and a network entity.

FIG. 6 illustrates example channel cluster structures between a UE and a network entity.

FIG. 7 illustrates an example reference signal configuration.

FIG. 8 depicts a method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for cluster information learning in frequency division duplex (FDD) systems.

Channel reciprocity in wireless communications systems refers to wireless transmission characteristics that are substantially the same in both directions of a communication link when operating in a same or similar frequency band. For example, uplink (UL) and downlink (DL) channel reciprocity may be generally assumed, for example, in a time division duplex (TDD) system. In a TDD system or scheme, UL and DL transmissions are separated by time rather than frequency. For example, a TDD system or scheme may allocate different time slots for UL and DL transmissions within a same or similar frequency band. In some cases, by using a single frequency for UL and DL transmissions, a TDD scheme may allow for more efficient radio frequency (RF) spectrum utilization, particularly for certain Third Generation Partnership Project (3GPP) 5G networks and services.

While certain UL-DL circuit calibration distinctions may exist between the device performing the UL transmission and the device performing the DL transmission, the same set of frequencies with the same RF properties is used in a TDD system or scheme. For example, certain devices can learn UL channel characteristics to be used from receiving a DL transmission, and certain devices can learn DL channel characteristics to be used from receiving an UL transmission. Knowledge of UL-DL channel reciprocity can assist in speeding up beamforming operations (e.g., initial beam acquisition and/or beam refinement processes) between devices communicating across a communication link.

FDD systems may be increasingly deployed in certain wireless communications systems, for example, in 3GPP 5G-Advanced and 6G networks. In an FDD system or scheme, separate frequency bands are used for the UL and DL transmissions. By using separate frequency bands, FDD systems or schemes allow for simultaneous transmission and reception, which can be advantageous in certain applications and services. For example, an FDD system may run uninterrupted, with no need for switching between UL and DL operations in the time domain. Thus, more stable and predictable communication patterns may be achieved using an FDD system or scheme.

However, a guard band is generally used between an UL frequency and a DL frequency, thereby making spectrum allocation less efficient and less flexible when using an FDD system or scheme. Moreover, the UL and DL frequency domain resources may be substantially separated along the allocated RF spectrum in certain FDD systems or schemes. For example, the UL frequencies may be configured in one bandwidth part (BWP) of the allocated RF spectrum, and the DL frequencies may be configured in a different BWP of the allocated RF spectrum. Accordingly, the UL transmission circuits of a device and the DL transmission circuits of the device will have slightly different behaviors in terms of frequency response. For example, the power amplifiers (PAs) of the UL transmission circuits may have a frequency response different from the frequency response of the low noise amplifiers (LNAs) of the DL transmission circuits.

Thus, wireless channels in FDD systems are typically not reciprocal. Channel information learning schemes in FDD systems generally include learning the UL channels from UL reference signals and separately learning the DL channels from DL reference signals. For example, DL channel information may be determined from DL reference signal configurations including demodulation reference signals (DMRSs) or channel state information reference signals (CSI-RSs), and UL channel information may be determined from separate UL reference signal configurations including sounding reference signals (SRSs).

In this manner, channel information learning for the DL transmissions is decoupled from channel information learning for the UL transmissions. Additionally, the reference signal resources allocated and associated signaling for separately learning the UL channels and DL channels can be significant. While accurate channel information for both the UL channels and the DL channels may be ascertained using these conventional channel information learning schemes, this approach in FDD systems can lead to considerable signaling overhead and device power increases.

Aspects described herein overcome the aforementioned technical problems associated with conventional channel information learning schemes in FDD systems or schemes. For example, UL and DL channels may be seen as having channel cluster structures in an FDD schemes. A particular channel cluster in an FDD scheme may have the same angular and delay information for departure and arrival rays corresponding to the UL transmission and the DL transmission. Using techniques to ascertain the same angular and delay information for departure and arrival rays for the particular channel cluster, the only varying transmission characteristics between the UL transmission and the DL transmission may be reduced to transmission gain characteristics (e.g., an amplitude gain, phase calibration, etc.). These transmission gain characteristics may then be applied by the device transmitting and receiving these simultaneous UL transmissions and DL transmissions for a particular channel cluster in accordance with the FDD scheme.

By applying the techniques described herein to efficiently learn channel clusters in FDD systems and schemes, technical advantages over conventional solutions may be realized. For example, signaling overhead may be reduced and device power usage may be decreased in operations to ascertain channel information for effective UL and DL transmissions in FDD systems or schemes. In some aspects, reference signal configurations and signaling techniques between devices communicating in an FDD system or scheme accelerate the process of channel acquisition and/or channel state information learning. These reference signal configurations and signaling techniques result in a reduction of the total signaling overhead and a decrease of the total device power.

For example, reference signal configurations described herein include UL reference signal transmissions and DL reference signal transmissions with associated periodicities and time parameters configured (e.g., optimized) for learning channel information in FDD systems or schemes. By using these reference signal configurations, a device can more effectively ascertain channel information beneficial for effective UL and DL transmissions in FDD systems, thereby reducing the computational efforts and device power associated therewith when performing channel estimation operations.

In some examples, channel estimation techniques may be applied to UL reference signal transmissions and DL reference signal transmissions of a particular reference signal configuration, and the channel estimation results may be signaled between devices in an FDD system or scheme. For example, bidirectional signaling including the channel estimation results may be performed between a user equipment (UE) and a network entity, thereby enabling each respective device to learn the azimuth angle of arrival (AoA), zenith angle of arrival (ZoA), azimuth angle of departure (AoD), zenith angle of departure (ZoD) parameter, delay, angular spread in azimuth and zenith, etc. of the corresponding device in the FDD system or scheme.

By using this bidirectional signaling and the associated channel information learnings, each respective device can reduce the total signaling overhead and the device power usage associated therewith in the operations to ascertain channel information necessary for effective UL and DL transmissions in FDD systems or schemes.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

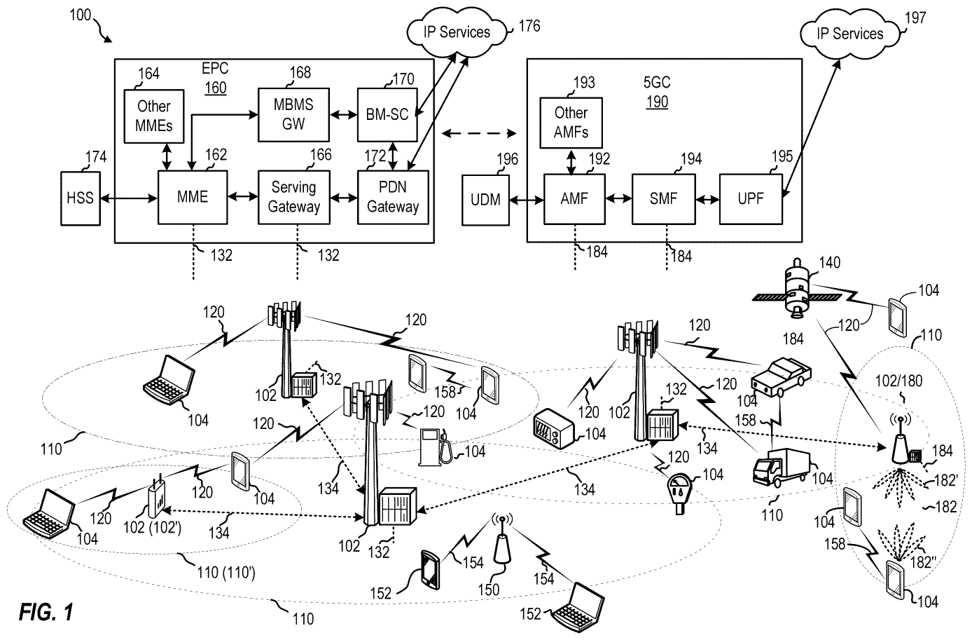

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

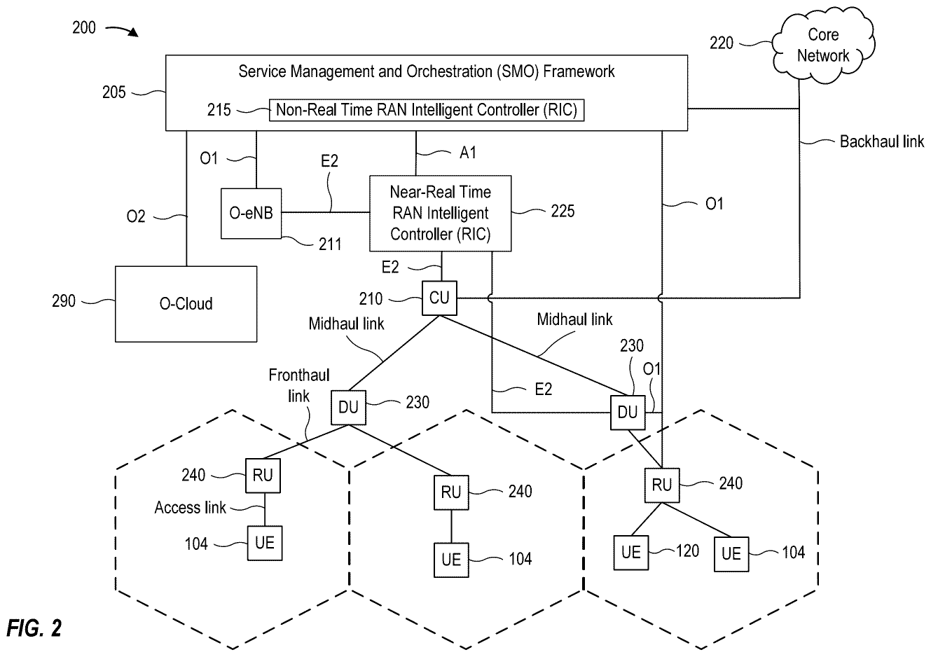

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

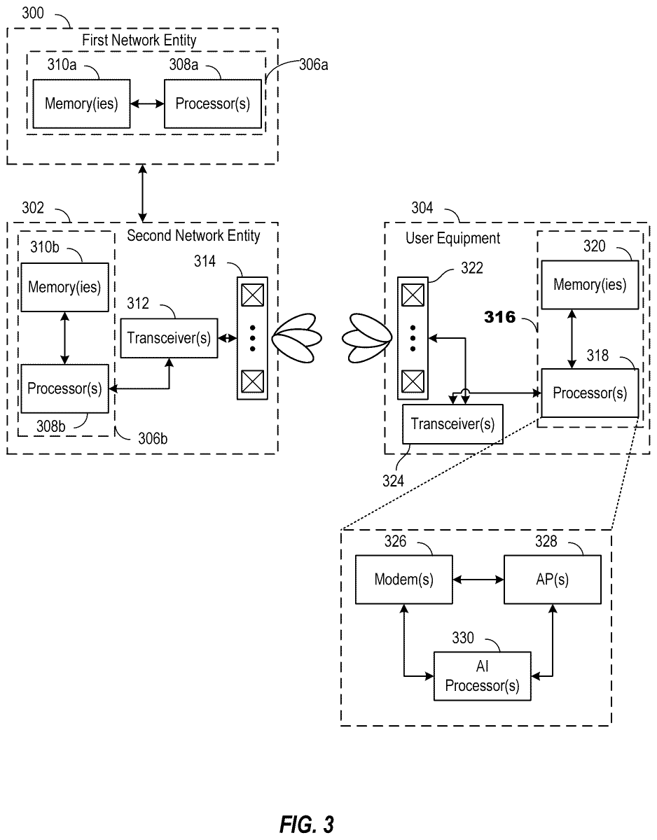

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory (ies) 310a” and “memory (ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

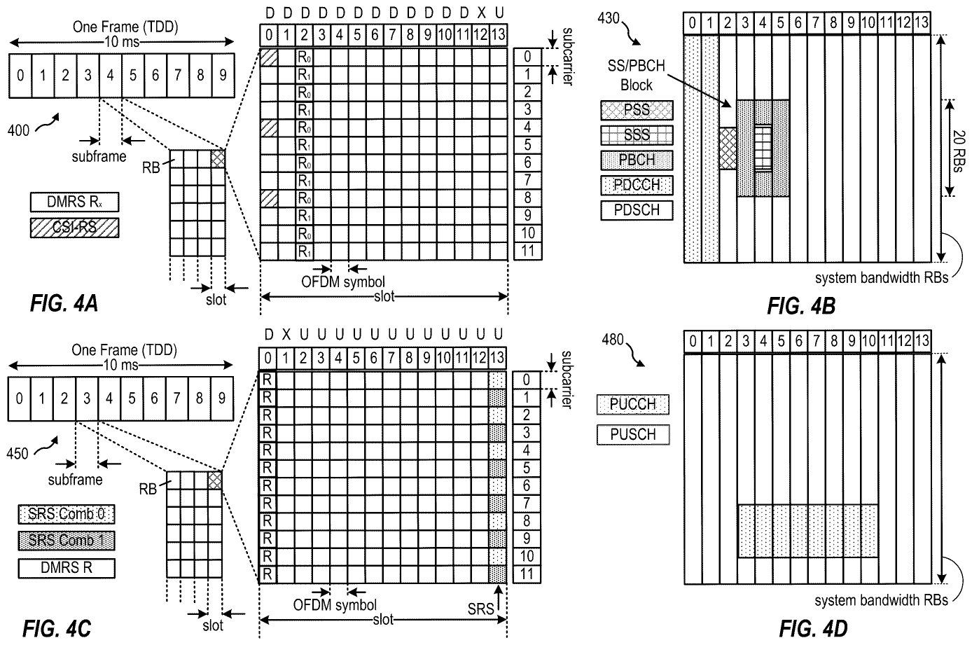

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Cluster Information Learning in FDD Systems

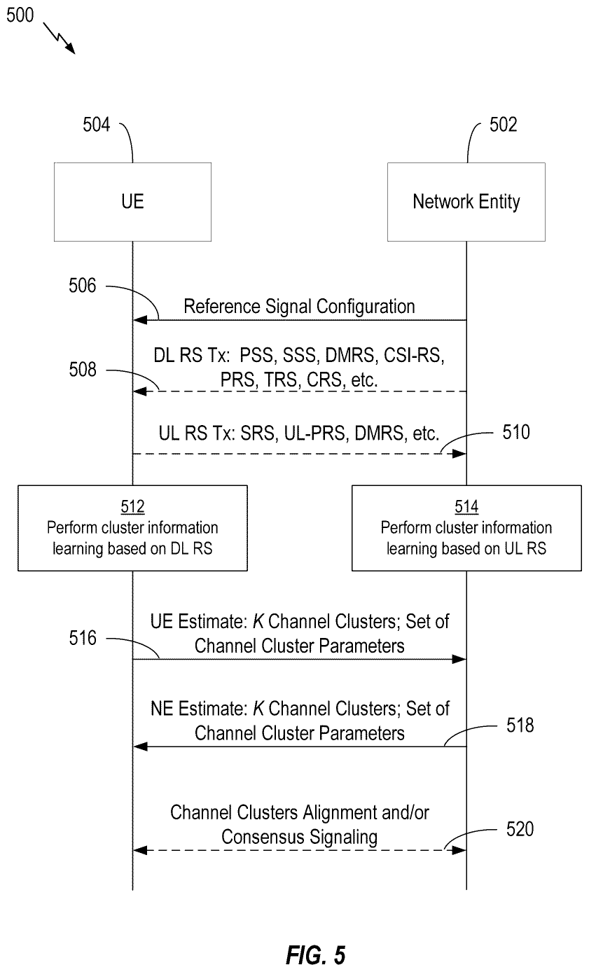

FIG. 5 is a diagram illustrating example 500 cluster information learning performed between a UE 504 and a network entity 502. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3. However, in other aspects, UE 504 may be another type of wireless communications device and network entity 502 may be another type of network entity or network node, such as those described herein.

As shown in example 500, at 506, the UE 504 may obtain (e.g., receive), and the network entity 502 may output (e.g., transmit), a reference signal configuration. The reference signal configuration may include both a DL reference signal configuration and an UL reference signal configuration, though in some aspects the DL reference signal configuration and the UL reference signal configuration may be configured as part of the same element. The reference signal configuration may be obtained via signaling from the network entity 502. For example, the network entity 502 may send the reference signal configuration 506 via RRC information element(s), MAC control elements (MAC-CEs), DCI messages, or any combination thereof. In some aspects, the reference signal configuration is associated with an FDD communication scheme. For example, the reference signal configuration may be signaled in association with (e.g., as part of configuration of, via) a cell or carrier associated with (e.g., configured to use) the FDD communication scheme. As another example, the UE 504 and the network entity 502 may communicate using the FDD communication scheme.

In some examples, the DL reference signal configuration and the UL reference signal configuration may be sent to the UE 504 via the same signaling transmission instance. In some examples, the DL reference signal configuration and the UL reference signal configuration are sent to the UE 504 via temporally separate transmissions.

The DL reference signal configuration may include (e.g., indicate resources or configurations for) DL reference signal transmissions. These DL reference signal transmissions may include a PSS, SSS, DMRS, CSI-RS, positioning reference signal (PRS), tracking reference signal (TRS), cell-specific reference signal (CRS), etc., or any combination thereof. The UL reference signal configuration may include (e.g., indicate resources or configurations for) UL reference signal transmissions. These UL reference signal transmissions may include an SRS, UL-PRS, DMRS, etc., or any combination thereof.

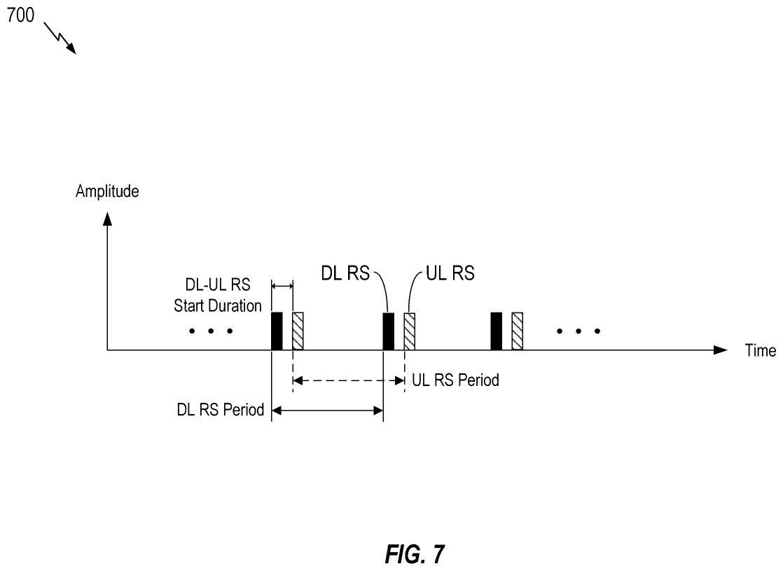

In some examples, the DL reference signal transmissions have a same periodicity as the UL reference signal transmissions. Additionally, or alternatively, each DL reference signal transmission may be proximate to a corresponding UL reference signal transmission. Various aspects of the reference signal configuration are described in connection with FIG. 7.

At 508, the UE 504 may obtain (e.g., receive, measure), and the network entity 502 may output (e.g., transmit), the DL reference signal transmissions in accordance with the DL reference signal configuration. At 510, the UE 504 may output (e.g., transmit), and the network entity 502 may obtain (e.g., receive, measure), the UL reference signal transmissions in accordance with the UL reference signal configuration.

The UE 504 may analyze the DL reference signal transmissions and perform cluster information learning (at 512). In performing cluster information learning, the UE 504 may ascertain various channel information associated with the DL channel based on obtaining the DL reference signal transmission that may correspond to an UL channel. For example, the UE 504 may estimate a number (K) of channel clusters. The UE 504 may also determine, for each channel cluster of the K channel clusters, a set of channel cluster parameters.

Similarly, network entity 502 may analyze the UL reference signal transmissions and perform cluster information learning (at 514). In performing cluster information learning, the network entity 502 may ascertain various channel information associated with the UL channel based on obtaining the UL reference signal transmission that may correspond to a DL channel. For example, the network entity 502 may estimate a number (K) of channel clusters. The number K of channel clusters estimated by the network entity 502 may be the same or different from the number of channel clusters estimated by the UE 504. The network entity 502 may also determine, for each channel cluster of the K channel clusters, a set of channel cluster parameters.

In some examples, each channel cluster that is estimated by the UE 504 or the network entity may correspond to a set of DL channels and UL channels that have similar transmission characteristics. The transmission characteristics in the set of UL and DL channels that may be similar for a particular channel cluster may include the channel environment (e.g., the reflection or scattering over a distinct object in the channel environment), the frequencies of the transmissions (e.g., UL and DL frequencies are sufficiently comparable), etc. The set of channel cluster parameters determined for each channel cluster may include an AoA parameter, ZoA parameter, AoD parameter, ZoD parameter, delay parameter, angular spread parameter in azimuth and zenith, or any combination thereof.

At 516, the UE 504 may output (e.g., transmit), for each channel cluster of the K channel clusters, a set of channel cluster parameters. For example, if the UE 504 estimates that four channel clusters exist between the UE 504 and the network entity 502, then the UE 504 may send a message to the network entity 502 indicating four channel clusters and four sets of channel cluster parameters.

Similarly, at 518, the network entity 502 may output (e.g., transmit), for each channel cluster of the K channel clusters, a set of channel cluster parameters. For example, if the network entity 502 estimates that three channel clusters exist between the network entity 502 and the UE 504, then the network entity 502 may send a message to the UE 504 indicating three channel clusters and three sets of channel cluster parameters.

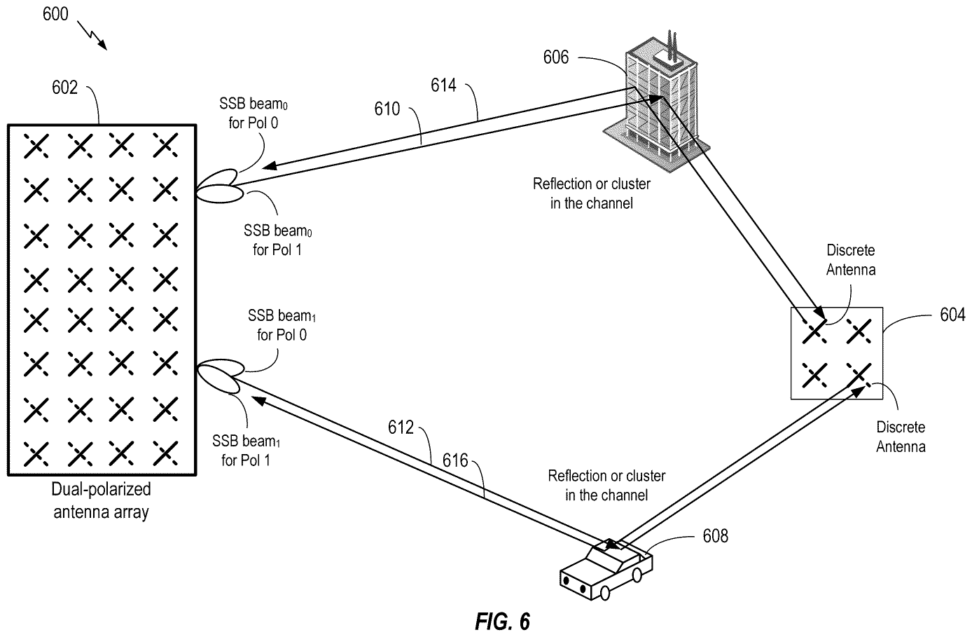

FIG. 6 illustrates example 600 channel cluster structures between a UE 604 and a network entity 602. In some aspects, the network entity 602 may be an example of the BS 102 depicted and described with respect to FIG. 1, the first network entity 300 or the second network entity 302 depicted and described with respect to FIG. 3, the network entity 502, or a disaggregated base station depicted and described with respect to FIG. 2. Similarly, the UE 604 may be an example of UE 104 depicted and described with respect to FIG. 1, the UE 504, or the UE 304 depicted and described with respect to FIG. 3. However, in other aspects, UE 604 may be another type of wireless communications device and network entity 602 may be another type of network entity or network node, such as those described herein.

Example 600 is described with respect to a MIMO channel setup for a FDD system. The network entity 602 may include a dual-polarized antenna array, and the UE 604 may include discrete antenna. An antenna element with a first polarization is indicated by a solid diagonal line and an antenna element with a second polarization is indicated by a dashed diagonal line.

The DL channels and UL channels have a similar cluster structure. For example, a channel cluster structure may include a same set of reflectors that propagate a transmitted signal from one node to the other. As shown in FIG. 6, the network entity 602 may transmit a first DL beam 610 from a first set of antenna elements. The first DL beam 610 may be reflected off of a first object 606 (e.g., building) and propagated to the UE 604, where it is received by a first discrete antenna element. In some examples, the first DL beam 610 may correspond to SSB beam₀ and includes a first polarization (Polarization 0) and a second polarization (Polarization 1).

The network entity 602 may also transmit a second DL beam 612 from a second set of antenna elements. The second DL beam 612 may be reflected off of a second object 608 (e.g., automobile) and propagated to the UE 604, where it is received by a second discrete antenna element. In some examples, the second DL beam 612 may correspond to SSB beam₁ and includes a first polarization (Polarization 0) and a second polarization (Polarization 1).

Similarly, the UE 604 may transmit a first UL beam 614 to the network entity 602 that may propagate and be reflected off of the first object 606 (e.g., building) following the same path as the first DL beam 610. Thus, the first DL beam 610 and the first UL beam 614 have the same AoA/ZoA, AoD/ZoD, delay, and angular information in azimuth and zenith, and are seen as forming a channel cluster. The first DL beam 610 and the first UL beam 614 may differ in terms of transmission gain (e.g., amplitude gain and phase calibration) of the respective paths. The UE 604 may output (e.g., transmit) a PUSCH transmission in accordance with the FDD communication scheme. For example, the PUSCH transmission may be based at least in part on a corresponding set of the channel cluster parameters (e.g., the same AoA/ZoA, AoD/ZoD, delay, and angular information in azimuth and zenith) for the channel cluster formed between the UE 604 and the network entity 602.

The UE 604 may also transmit a second UL beam 616 to the network entity 602 that may propagate and be reflected off of the second object 608 (e.g., automobile) following the same path as the second DL beam 612. Thus, the second DL beam 612 and the second UL beam 616 also have the same AoA/ZoA, AoD/ZoD, delay, and angular information in azimuth and zenith, and are seen as forming another channel cluster.

Various approaches to channel information learning are contemplated and described for FDD systems and schemes. As shown in FIG. 6, each channel cluster may correspond to propagation between a transmitter node and a receiver node. That is, for example, each channel cluster may correspond to a similar reflection and/or scattering of DL and UL beams over a distinct object in the channel environment. Additionally, each channel cluster may correspond to the DL frequencies of the DL transmissions and the UL frequencies of the UL transmissions being sufficiently comparable, despite not being the same as in a TDD system or scheme.

For example, while the DL channel matrix (HDL) and the UL channel matrix (HUL) are different (e.g., on a per-realization basis) on DL and UL, the cluster angular and delay info remain the same with gains changing across frequencies. HDL and HUL are represented in Equations (1A) and (1B), respectively, below:

$${H}_{DL} = {\sum }_{nm} {α}_{nm} \cdot {a}_{R} ( {θ}_{R , nm} , {ϕ}_{R , nm} ) \cdot {( {a}_{T} ( {θ}_{T , nm} , {ϕ}_{T , nm} ) )}^{H} \cdot {e}^{j 2 π B \text{?} t \cdot ( \vec{{r}_{nm}} \cdot \text{?} )} \cdot {e}^{- j 2 π k \text{?} {τ}_{nm}}$$

$${H}_{UL} = {\sum }_{nm} {β}_{nm} \cdot {a}_{T} ( {θ}_{T , nm} , {ϕ}_{T , nm} ) \cdot {( {a}_{R} ( {θ}_{R , nm} , {ϕ}_{R , nm} ) )}^{H} \cdot {e}^{j 2 π B \text{?} t \cdot ( \vec{{r}_{nm}} \cdot \text{?} )} \cdot {e}^{- j 2 π k \text{?} {τ}_{nm}}$$

$$\text{?} \text{indicates text missing or illegible when filed}$$

In an FDD system or scheme, where the DL frequencies and the UL frequencies are similar but not the same, let αₙₘ=|αₙₘ|e^{jv}ₙₘ and βₙₘ=βₙₘ|e^{jε}ₙₘ, and in general, the result is |αₙₘ|≠|βₙₘ| and ^{v}ₙₘ≠^{ε}ₙₘ. That is, for example, the amplitude gain and the phase calibration are different for the DL transmissions and the UL transmissions based on the differences in DL frequencies and the UL frequencies. However, common channel cluster parameters including AoA/ZoA, AoD/ZOD, delay, and angular information in azimuth and zenith may be learned by both the network entity 602 and UE 604.

For example, a bidirectional channel information learning scheme may include channel estimation techniques performed at both the network entity 602 and the UE 604 to learn the AoA/ZoA, AoD/ZoD, delay, and angular information in azimuth and zenith. In some examples, MUSIC (MUltiple SIgnal Classification), an algorithm used for frequency estimation and radio direction finding, may be used as the channel estimation techniques. Additionally, or alternatively, ESPRIT (Estimation of Signal Parameters via Rotational Invariance Techniques), a signal parameter estimation technique that uses the rotational invariance of a signal subspace to estimate the direction of arrival, may be used as the as the channel estimation techniques.

Subsequent signaling of the results may be performed from the UE 604 to the network entity 602, and from the network entity 602 to the UE 604. Based on UL-DL amplitude gain and phase calibration, the channel cluster structure can be learned on both sides of the link (e.g., the UE 604 side and the network entity 602 side) to accelerate channel acquisition and channel state information learning for FDD communications.

FIG. 7 illustrates an example 700 reference signal configuration that may be used in learning the channel cluster structures. Reference signals are shown along a time axis and an amplitude axis. Referring back to FIG. 5, the network entity 502 may configure a periodic allocation of DL reference signals and UL reference signals. For example, the reference signal configuration may include resources allocating CSI-RSs as the DL reference signals and SRSs as the UL reference signals to allow the UE 504 to estimate the DL covariance matrix and network entity 502 to estimate the UL covariance matrix.

The DL reference signals have a same periodicity as the UL reference signals. As shown in FIG. 7, the DL reference signal period is the same time duration as the UL reference signal period, albeit offset along the time axis. This UL periodicity is configured to allow both the network entity 502 and the UE 504 to track the covariance matrices of the DL channel and the UL channel with channel mobility and/or Doppler effects. In some examples, the UE 504 may obtain (e.g., receive) a new or updated periodicity from network entity 502. This new or updated periodicity value may then serve as same periodicity of the DL reference signal transmissions and the UL reference signal transmissions. For example, the second periodicity may be based at least in part on variance attributes (e.g., channel mobility and/or Doppler effects) determined by the UE 504, the network entity 502, or both. These variance attributes may be determined while estimations for the DL covariance matrix and/or the UL covariance matrix are being performed.

For example, these variance attributes may be determined during measurements made with respect to the DL reference signal transmissions for estimating the DL channels and/or with respect to the UL reference signal transmissions for estimating the UL channels one or more uplink channels. The new or updated periodicity may be shorter or longer than the initial periodicity based on these variance attributes. In some examples, the new or updated periodicity may be shorter than the initial periodicity due to a determination that channel mobility and Doppler effects are increasing between the network entity 502 and the UE 504.

In some examples, the reference signal configuration may include UL frequencies that are configured in one BWP of the allocated RF spectrum. The reference signal configuration may also include DL frequencies that are configured in a different BWP of the allocated RF spectrum. In some examples, the BWP configured for the UL frequencies is sufficiently proximal to the BWP for the DL frequencies with respect to the radio frequency spectrum supported by the UE 504. In some examples, the BWP configured for the UL frequencies and the BWP for the configured for the DL frequencies satisfy an RF spectrum threshold. For example, a center frequency of the BWP for the UL frequencies is not to be more than a delta frequency value from a center frequency of the BWP for the DL frequencies. That is, for example, in order to use different BWPs in the reference signal configuration, the RF spectrum threshold is satisfied by the BWPs selected for use in the FDD communication scheme. In some examples, both the BWP for the UL frequencies and the BWP for the DL frequencies are configured to have a RF frequency greater than the 3 GHz.

In some examples, a time duration of the DL-UL reference signal start duration is shorter than the time duration of the DL reference signal period. That is, for example, the DL-UL reference signal start duration correspond to a DL reference signal transmission and a corresponding UL reference signal transmission. In this situation, the DL reference signals may be referred to as being proximate to the UL reference signals in time. Additionally, or alternatively, a DL reference signal may be considered proximate to a UL reference signal in time if a ratio between a time duration of the DL-UL reference signal start duration (e.g., offset) and a time duration of the DL reference signal period is lower than a threshold. For example, the threshold may be defined as X, where X may be, for example, 0.1, 0.2, 0.3, in a range of 0 to 0.3, in a range of 0 to 0.1, or the like. Also, the DL reference signal period is the same time duration as the UL reference signal period.

Upon reception/measurement of the reference signal transmissions, the UE 504 and the network entity 502 may perform channel cluster learning. For example, after the n-th round of reference signal transmissions from both the network entity 502 and the UE 504 (where a round includes a DL reference signal transmission and a UL reference signal transmission and where n is at least 1), the UE 504 and the network entity 502 can estimate or update sample covariance matrices, represented in Equations (2A) and (2B), respectively, below:

$${S}_{n} = \frac{1}{n} {{\sum }_{i = 1}}^{n} {z}_{i} {z}_{i}^{H} where {S}_{n} \to S = E [ {H}_{DL} {H}_{DL}^{H} ]$$

$${R}_{n} = \frac{1}{n} {{\sum }_{i = 1}}^{n} {y}_{i} {y}_{i}^{H} where {R}_{n} \to R = E [ {H}_{UL} {H}_{UL}^{H} ]$$

From Sₙ and Rₙ, the eigenvectors of the covariance matrices can be estimated as follows:

$${S}_{n} = {U}_{n} {Λ}_{n} {U}_{n}^{H}$$

$${R}_{n} = {V}_{n} {Γ}_{n} {U}_{n}^{H}$$

From Sₙ, the UE 504 estimates a number (K_{UE}) of channel clusters and AoA/ZoA, AoD/ZoD, delay, and angular information in azimuth and zenith (as seen from the DL perspective). These estimates may be based at least in part eigenvectors associated with the DL reference signal transmissions. In some examples, the UE 504 may estimate K_{UE} and these parameters based on Equation (3A):

$${\{ {θ}_{1} , … , {θ}_{K} \} \vert}_{AoA , ZoA} = arg {max}_{θ} P ( θ )$$

$$P ( θ ) = \frac{1}{{\sum }_{h = K + 1}^{N} {\vert {a ( θ )}^{H} {u}_{k}^{n} \vert}^{2}}$$

From Rₙ, the network entity 502 estimates a number (K_{NE}) of channel clusters and AoA/ZoA, AoD/ZoD, delay, and angular information in azimuth and zenith (as seen from the UL perspective). These estimates may be based at least in part eigenvectors associated with the UL reference signal transmissions. In some examples, the network entity 502 may estimate K_{NE} and these parameters based on Equation (3B):

$${\{ {θ}_{1} , … , {θ}_{K} \} \vert}_{AoD , ZoD} = arg {max}_{θ} Q ( θ )$$

$$Q ( θ ) = \frac{1}{{\sum }_{h = K + 1}^{N} {\vert {a ( θ )}^{H} {v}_{k}^{n} \vert}^{2}}$$

To determine the number (K) of clusters at each end (e.g., the UE 504 end and the network entity 502 end), the UE 504 may estimate the noise subspace dimensionality based on Sₙ (e.g., thresholding of eigenvalues where the threshold is configured) and the network entity 502 may estimate the noise subspace dimensionality based on Rₙ (e.g., thresholding of eigenvalues where the threshold is configured).

After the cluster information learning has been completed, at 520, signaling between the UE 504 and the network entity 502 may be performed to to align and/or enable consensus on learning the channel cluster structure in the FDD system or scheme.

For example, UE 504 may output (e.g., transmit or communicate) the number (K_{UE}) of channel clusters and the AoA/ZoA, AoD/ZOD, delay, and angular information in azimuth and zenith to the network entity 502. In some examples, the UE 504 may also output (e.g., transmit) an indication that the network entity 502 is to align with the first number of the one or more channel clusters, and a corresponding set of the number (K_{UE}) of channel clusters and the corresponding parameters for each channel cluster of the K_{UE} channel clusters.

In another example, the UE 504 may output (e.g., transmit) an indication that that the network entity 502 is to choose whether to align with the number (K_{UE}) of channel clusters and the corresponding parameters for each channel cluster of the K_{UE} channel clusters, or whether to suggest a different number (e.g., K_{NE} or a different K value) of the channel clusters. The UE 504 and the network entity 502 may iterate (e.g., via subsequent signaling back and forth) to determine the appropriate value for the number (K) of channel clusters to use.

Additionally, or alternatively, the UE 504 obtain (e.g., receive) the number (K_{NE}) of channel clusters and the AoA/ZoA, AoD/ZoD, delay, and angular information in azimuth and zenith from the network entity 502. In some examples, the UE 504 may determine (e.g., a priori) to align with the number (K_{NE}) of channel clusters and the AoA/ZoA, AoD/ZoD, delay, and angular information in azimuth and zenith obtained from the network entity 502. In some examples, the UE 504 may obtain (e.g., receive) an explicit indication from the network entity 502 that the UE 504 is to align with the number (K_{NE}) of channel clusters and the AoA/ZoA, AoD/ZoD, delay, and angular information in azimuth and zenith obtained from the network entity 502.

In yet another example, the UE 504 may select whether to align with the number (K_{NE}) of channel clusters and the corresponding parameters for each channel cluster of the K_{NE} channel clusters, or whether to suggest a different number (e.g., K_{UE} or a different K value) of the channel clusters. In some cases, the UE 504 may obtain (e.g., receive) an explicit indication that the UE 504 is to make such a selection. Similarly, the UE 504 and the network entity 502 may iterate (e.g., via subsequent signaling back and forth) to determine the appropriate value for the number (K) of channel clusters to use.

Once the network entity 502 and the UE 504 estimate the AoA/ZoA, AoD/ZoD, delay, and angular information in azimuth and zenith of all the number (K) of channel clusters, the UE 504 may perform timing estimation techniques to estimate a tap delay value as the network entity 502 beamforms (e.g., perform beamforming operations and transmits beam) along each direction associated with the number (K) of channel clusters. The UE 504 may output (e.g., transmit) the corresponding tap delay values to the network entity 502.

Additionally, or alternatively, the UE 504 may perform channel impulse response (CIR) estimation techniques to estimate a complex gain value as the network entity 502 beamforms (e.g., perform beamforming operations and transmits beam) along each direction associated with the number (K) of channel clusters. In some examples, the UE 504 may perform UL-DL calibration techniques to aid in estimating a corresponding complex gain of the k-th cluster for the UL channel of the number (K) of channel clusters. The UE 504 may output (e.g., transmit) the corresponding complex gain values to the network entity 502.

In some examples, the network entity 502 may utilize the corresponding tap delay values, corresponding complex gain values, or both, to can estimate the DL channel matrix, the UL channel matrix, or both.

In some examples, once the number (K) of channel clusters has been determined, the UE 504 may determine how one network entity polarization impacts the other network entity polarization. For example, the UE 504 may determine this polarization impact based on CIR measurements from the corresponding two-port transmissions (e.g., where the network entity 502 transmits data using two separate antenna ports) associated with DL reference signal transmissions and/or DL transmissions subsequent or in addition to the DL reference signal transmissions.

In some examples, the UE 504 may perform DL-UL calibration techniques in addition to the IR measurements from the corresponding two-port transmissions to determine the polarization impact information. The UE 504 may output (e.g., transmit) this polarization impact information to the network entity 502.

### Example Operations of a User Equipment

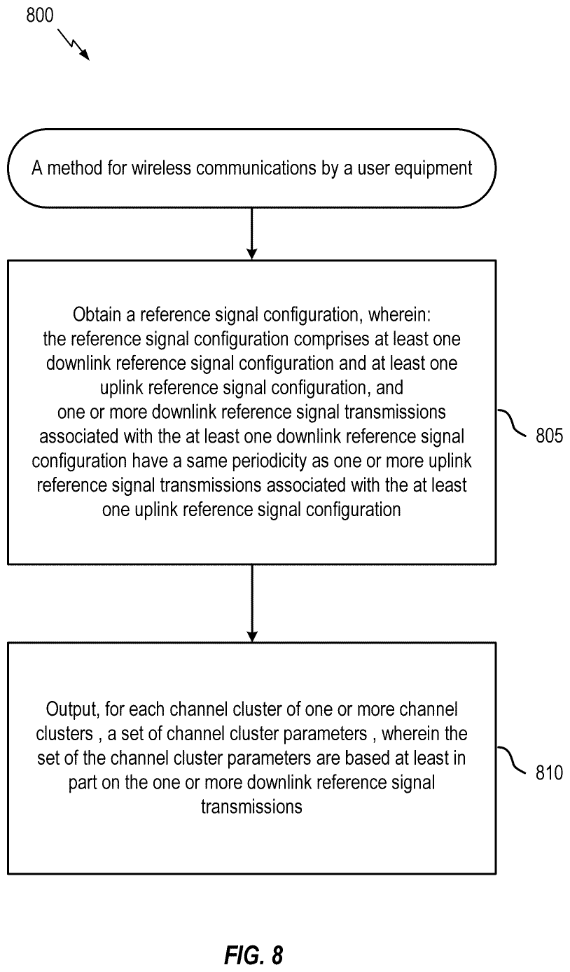

FIG. 8 shows a method 800 for wireless communications by an apparatus, such as UE 104 of FIG. 1, UE 304 of FIG. 3, or UE 504 of FIG. 5. In some examples, however, the method 800 for wireless communications may be performed in a comparable manner by an apparatus, such as BS 102 of FIG. 1, network entity 300 or network entity 302 of FIG. 3, or a disaggregated base station as discussed with respect to FIG. 2, or network entity 502 of FIG. 5.

Method 800 begins at block 805 with obtaining a reference signal configuration (e.g., as shown at 506 or 700 with respect to FIG. 7). In some cases, the reference signal configuration may include at least one downlink reference signal configuration and at least one uplink reference signal configuration. In some cases, one or more downlink reference signal transmissions associated with the at least one downlink reference signal configuration may have a same periodicity (e.g., DL reference signal period of FIG. 7) as one or more uplink reference signal transmissions associated with the at least one uplink reference signal configuration.

Method 800 then proceeds to block 810 with outputting, for each channel cluster of one or more channel clusters a set of channel cluster parameters (e.g., as shown at 516). In some cases, the set of the channel cluster parameters may be based at least in part on the one or more downlink reference signal transmissions.

In some aspects, each channel cluster of the one or more channel clusters corresponds to a set of downlink channels and uplink channels that have one or more similar transmission characteristics.

In some aspects, the set of the channel cluster parameters includes an angle of arrival (AoA) parameter, a zenith angle of arrival (ZoA) parameter, an angle of departure (AoD) parameter, a zenith angle of departure (ZoD) parameter, a delay parameter, an angular spread parameter in azimuth and zenith, or any combination thereof.

In some aspects, method 800 further includes outputting a first number of the one or more channel clusters (e.g., the number (K_{NE}) of channel clusters), wherein the first number of the one or more channel clusters is based at least in part on one or more first eigenvectors associated with the one or more downlink reference signal transmissions.

In some aspects, method 800 further includes at least one of: outputting a first indication that a network entity is to align with the first number of the one or more channel clusters, and a corresponding set of the channel cluster parameters, for each channel cluster of the first number of the one or more channel clusters; or outputting a second indication that the network entity is to choose whether to align with the first number of the one or more channel clusters, and a corresponding set of the channel cluster parameters, for each channel cluster of the first number of the one or more channel clusters, or whether to suggest a number of the one or more channel clusters different from the first number.

In some aspects, method 800 further includes obtaining a second number of the one or more channel clusters (e.g., the number (K_{NE}) of channel clusters), wherein the second number of the one or more channel clusters is based at least in part on one or more second eigenvectors associated with the one or more uplink reference signal transmissions.

In some aspects, method 800 further includes at least one of: aligning with the second number of the one or more channel clusters, and a corresponding set of the channel cluster parameters, for each channel cluster of the second number of the one or more channel clusters; or selecting whether to align with the second number of the one or more channel clusters, and a corresponding set of the channel cluster parameters, for each channel cluster of the second number of the one or more channel clusters, or whether to suggest a number of the one or more channel clusters different from the second number.

In some aspects, method 800 further includes estimating a tap delay value for each channel cluster of the one or more channel clusters; estimating a complex gain value for each channel cluster of the one or more channel clusters; and outputting the tap delay value and the complex gain value for each corresponding channel cluster.

In some aspects, the same periodicity is defined by a first periodicity value (e.g., DL reference signal period of FIG. 7), and the method further includes obtaining a second periodicity value for the same periodicity of the one or more downlink reference signal transmissions and the one or more uplink reference signal transmissions, wherein the second periodicity value is based at least in part on variance attributes (e.g., channel mobility and/or Doppler effects) associated with one or more first covariance matrices of one or more downlink channels or one or more second covariance matrices of one or more uplink channels.

In some aspects, method 800 further includes outputting channel polarization information, wherein the channel polarization information is estimated based at least in part on the one or more downlink reference signal transmissions.

In some aspects, the at least one downlink reference signal configuration is associated with a first bandwidth part (BWP) and the at least one uplink reference signal configuration is associated with a second BWP different from the first BWP.

In some aspects, the reference signal configuration includes a first time duration (e.g., DL-UL start duration of FIG. 7) that is shorter than a second time duration (e.g., DL reference signal period of FIG. 7), the first time duration is between a first downlink reference signal transmission of the one or more downlink reference signal transmissions and a corresponding first uplink reference signal transmission of the one or more uplink reference signal transmissions within a periodicity of the one or more downlink reference signal transmissions, and the second time duration is the periodicity of the one or more downlink reference signal transmissions.

In some aspects, the reference signal configuration is associated with a frequency division duplex (FDD) communication scheme.

In some aspects, method 800 further includes outputting a physical uplink shared channel (PUSCH) transmission in accordance with the FDD communication scheme based at least in part on a corresponding set of the channel cluster parameters for a first channel cluster of the one or more channel clusters.

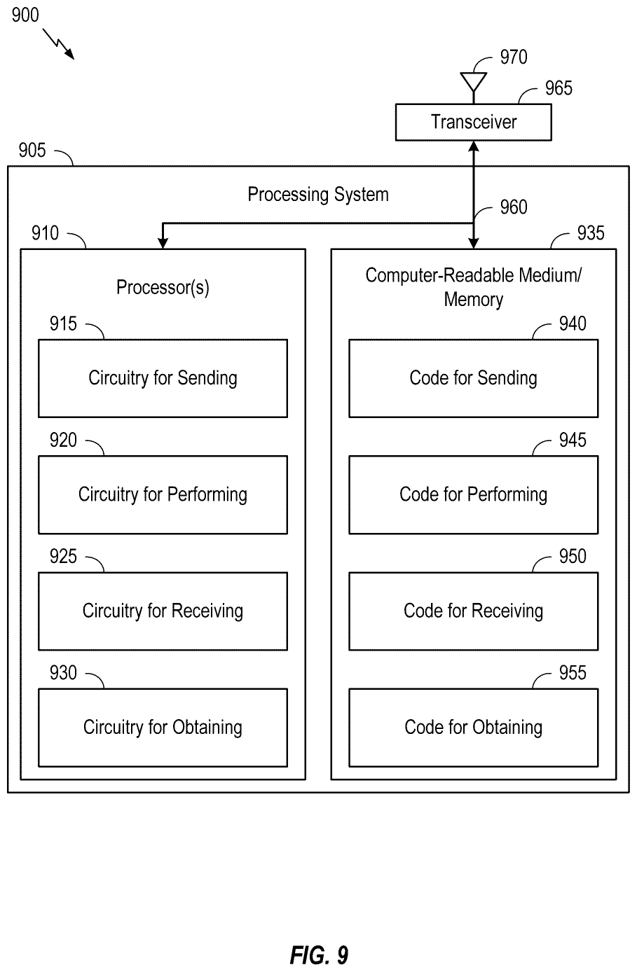

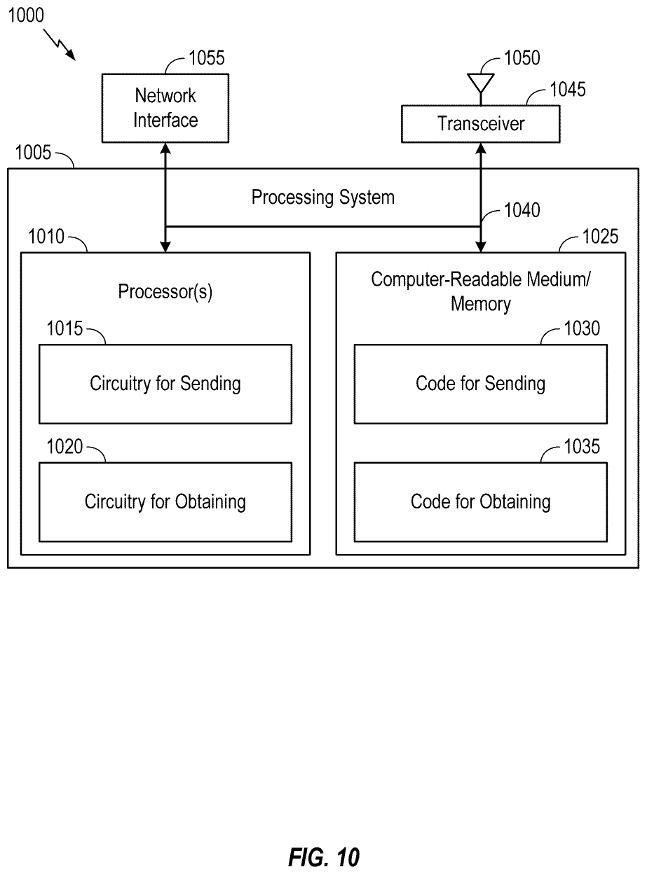

In some aspect, method 800, or any aspect related to it, may be performed by an apparatus, such as communications device 900 of FIG. 9 or communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 965 (e.g., a transmitter and/or a receiver). The transceiver 965 is configured to transmit and receive signals for the communications device 900 via an antenna 970, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 935. In various aspects, the one or more processors 910 may be representative of the one or more processors 318 described with respect to FIG. 3. The one or more processors 910 are coupled to a computer-readable medium/memory 935 via a bus 960. In some aspects, the computer-readable medium/memory 935 may be representative of the one or more memories 320 described with respect to FIG. 3. The computer-readable medium/memory 935 is a non-transitory computer-readable medium/memory. In certain aspects, the computer-readable medium/memory 935 is configured to store instructions (e.g., computer-executable code), that when executed by the one or more processors 910, cause the one or more processors 910 to perform the method 800 described with respect to FIG. 8, or any aspect related to it, including any operations described in relation to FIG. 8. Note that reference to a processor performing a function of communications device 900 may include one or more processors performing that function of communications device 900, such as in a distributed fashion.

In the depicted example, computer-readable medium/memory 935 stores code (e.g., executable instructions), including code for sending 940, code for performing 945, code for receiving 950, and code for obtaining 955. Processing of the code 940-955 may enable and cause the communications device 900 to perform the method 800 described with respect to FIG. 8, or any aspect related to it.

The one or more processors 910 include circuitry configured to implement (e.g., execute) the code stored in the computer-readable medium/memory 935, including circuitry for sending 915, circuitry for performing 920, circuitry for receiving 925, and circuitry for obtaining 930. Processing with circuitry 915-930 may enable and cause the communications device 900 to perform the method 800 described with respect to FIG. 8, or any aspect related to it. In some aspects, the circuitry for receiving 925 comprises circuitry for receiving a reference signal configuration. In some aspects, the circuitry for obtaining 930 comprises circuitry for obtaining a reference signal configuration. In some aspects, the circuitry for sending 915 comprises circuitry for outputting, for each channel cluster of one or more channel clusters, a set of channel cluster parameters.

More generally, means for communicating, transmitting, sending or outputting for transmission may include the one or more transceivers 324, one or more antenna 322 and/or processing system 316 of the UE 304 illustrated in FIG. 3, transceiver 965 and/or antenna 970 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 965 and/or antenna 970 of the communications device 900 in FIG. 9, and/or one or more processors 910 of the communications device 900 in FIG. 9.

FIG. 10 depicts aspects of an example communications device configured for wireless communications. In some aspects, communications device 1000 is a network entity, such as BS 102 of FIG. 1, first network entity 300 or second network entity 302 of FIG. 3, or a disaggregated base station as discussed with respect to FIG. 2.

The communications device 1000 includes a processing system 1005 coupled to a transceiver 1045 (e.g., a transmitter and/or a receiver) and/or a network interface 1055. The transceiver 1045 is configured to transmit and receive signals for the communications device 1000 via an antenna 1050, such as the various signals as described herein. The network interface 1055 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010 and a computer-readable medium/memory 1025. In various aspects, one or more processors 1010 may be representative of the one or more processors 308, as described with respect to FIG. 3. The one or more processors 1010 are coupled to the computer-readable medium/memory 1025 via a bus 1040. In certain aspects, the computer-readable medium/memory 1025 is configured to store instructions (e.g., computer-executable code), including code 1030 and 1035, that when executed by the one or more processors 1010, cause the one or more processors 1010 to perform the method 800 described with respect to FIG. 8, or any aspect related to it, including any operations described in relation to FIG. 8. The computer-readable medium/memory 1025 is a non-transitory computer-readable medium/memory. Note that reference to a processor of communications device 1000 performing a function may include one or more processors of communications device 1000 performing that function, such as in a distributed fashion.

In the depicted example, the computer-readable medium/memory 1025 stores code (e.g., executable instructions), including code for sending 1030 and code for obtaining 1035. Processing of the code 1030 and 1035 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1025, including circuitry for sending 1015 and circuitry for obtaining 1020. Processing with circuitry 1015 and 1020 may enable and cause the communications device 1000 to perform the method 800 described with respect to FIG. 8, or any aspect related to it.

Various components of the communications device 1000 may provide means for performing the method 800 described with respect to FIG. 8, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1045, antenna 1050, and/or network interface 1055 of the communications device 1000 in FIG. 10, and/or one or more processors 1010 of the communications device 1000 in FIG. 10. Means for communicating, receiving or obtaining may include the one or more transceivers 312, one or more antennas 314, and/or processing system 306 of the first network entity 300 or the second network entity 302 illustrated in FIG. 3, transceiver 1045, antenna 1050, and/or network interface 1055 of the communications device 1000 in FIG. 10, and/or one or more processors 1010 of the communications device 1000 in FIG. 10.

### Example Clauses

Implementation examples are described in the following numbered clauses:
Clause 1: A method for wireless communications by a user equipment (UE), the method comprising: obtaining a reference signal configuration, wherein: the reference signal configuration comprises at least one downlink reference signal configuration and at least one uplink reference signal configuration, and one or more downlink reference signal transmissions associated with the at least one downlink reference signal configuration have a same periodicity as one or more uplink reference signal transmissions associated with the at least one uplink reference signal configuration; and outputting, for each channel cluster of one or more channel clusters, a set of channel cluster parameters, wherein the set of the channel cluster parameters are based at least in part on the one or more downlink reference signal transmissions.
Clause 2: The method of Clause 1, wherein each channel cluster of the one or more channel clusters corresponds to a set of downlink channels and uplink channels that have one or more similar transmission characteristics.
Clause 3: The method of any one of Clauses 1 and 2, wherein the set of the channel cluster parameters comprises an angle of arrival (AoA) parameter, a zenith angle of arrival (ZoA) parameter, an angle of departure (AoD) parameter, a zenith angle of departure (ZoD) parameter, a delay parameter, an angular spread parameter in azimuth and zenith, or any combination thereof.
Clause 4: The method of any one of Clauses 1-3, further comprising: outputting a first number of the one or more channel clusters, wherein the first number of the one or more channel clusters is based at least in part on one or more first eigenvectors associated with the one or more downlink reference signal transmissions.
Clause 5: The method of any one of Clause 4, further comprising at least one of: outputting a first indication that a network entity is to align with the first number of the one or more channel clusters, and a corresponding set of the channel cluster parameters, for each channel cluster of the first number of the one or more channel clusters; or outputting a second indication that the network entity is to choose whether to align with the first number of the one or more channel clusters, and a corresponding set of the channel cluster parameters, for each channel cluster of the first number of the one or more channel clusters, or whether to suggest a number of the one or more channel clusters different from the first number.
Clause 6: The method of any one of Clauses 1-5, further comprising: obtaining a second number of the one or more channel clusters, wherein the second number of the one or more channel clusters is based at least in part on one or more second eigenvectors associated with the one or more uplink reference signal transmissions.
Clause 7: The method of any one of Clause 6, further comprising at least one of: aligning with the second number of the one or more channel clusters, and a corresponding set of the channel cluster parameters, for each channel cluster of the second number of the one or more channel clusters; or selecting whether to align with the second number of the one or more channel clusters, and a corresponding set of the channel cluster parameters, for each channel cluster of the second number of the one or more channel clusters, or whether to suggest a number of the one or more channel clusters different from the second number.
Clause 8: The method of any one of Clauses 1-7, further comprising: estimating a tap delay value for each channel cluster of the one or more channel clusters; estimating a complex gain value for each channel cluster of the one or more channel clusters; and outputting the tap delay value and the complex gain value for each corresponding channel cluster.
Clause 9: The method of any one of Clauses 1-8, wherein the same periodicity is defined by a first periodicity value and the method further comprises: obtaining a second periodicity value for the same periodicity of the one or more downlink reference signal transmissions and the one or more uplink reference signal transmissions, wherein the second periodicity value is based at least in part on variance attributes associated with one or more first covariance matrices of one or more downlink channels or one or more second covariance matrices of one or more uplink channels.
Clause 10: The method of any one of Clauses 1-9, further comprising: outputting channel polarization information, wherein the channel polarization information is estimated based at least in part on the one or more downlink reference signal transmissions.
Clause 11: The method of any one of Clauses 1-10, wherein the at least one downlink reference signal configuration is associated with a first bandwidth part (BWP) and the at least one uplink reference signal configuration is associated with a second BWP different from the first BWP.
Clause 12: The method of any one of Clauses 1-11, wherein: the reference signal configuration comprises a first time duration that is shorter than a second time duration, the first time duration is between a first downlink reference signal transmission of the one or more downlink reference signal transmissions and a corresponding first uplink reference signal transmission of the one or more uplink reference signal transmissions within a periodicity of the one or more downlink reference signal transmissions, and the second time duration is the periodicity of the one or more downlink reference signal transmissions.
Clause 13: The method of any one of Clauses 1-12, wherein the reference signal configuration is associated with a frequency division duplex (FDD) communication scheme.
Clause 14: The method of Clause 13, further comprising: outputting a physical uplink shared channel (PUSCH) transmission in accordance with the FDD communication scheme based at least in part on a corresponding set of the channel cluster parameters for a first channel cluster of the one or more channel clusters.
Clause 15: One or more apparatuses, comprising: one or more memories comprising executable instructions; and one or more processors configured to execute the executable instructions and cause the one or more apparatuses to perform a method in accordance with any one of Clauses 1-14.
Clause 16: One or more apparatuses configured for wireless communications, comprising: one or more memories; and one or more processors, coupled to the one or more memories, configured to cause the one or more apparatuses to perform a method in accordance with any one of Clauses 1-14.
Clause 17: One or more apparatuses configured for wireless communications, comprising: one or more memories; and one or more processors, coupled to the one or more memories, configured to perform a method in accordance with any one of Clauses 1-14.
Clause 18: One or more apparatuses, comprising means for performing a method in accordance with any one of Clauses 1-14.
Clause 19: One or more non-transitory computer-readable media comprising executable instructions that, when executed by one or more processors of one or more apparatuses, cause the one or more apparatuses to perform a method in accordance with any one of Clauses 1-14.
Clause 20: One or more computer program products embodied on one or more computer-readable storage media comprising code for performing a method in accordance with any one of Clauses 1-14.
Clause 21: One or more apparatuses configured for wireless communications, comprising: a processing system that includes one or more processors and one or more memories coupled with the one or more processors, the processing system configured to cause the one or more apparatuses to perform a method in accordance with any one of Clauses 1-14.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, the apparatus comprising a processing system that includes one or more processors and one or more memories coupled with the one or more processors, the processing system configured to cause a user equipment (UE) to:
obtain a reference signal configuration, wherein:
the reference signal configuration comprises at least one downlink reference signal configuration and at least one uplink reference signal configuration, and
one or more downlink reference signal transmissions associated with the at least one downlink reference signal configuration have a same periodicity as one or more uplink reference signal transmissions associated with the at least one uplink reference signal configuration; and
output, for each channel cluster of one or more channel clusters, a set of channel cluster parameters, wherein the set of the channel cluster parameters are based at least in part on the one or more downlink reference signal transmissions.

2. The apparatus of claim 1, wherein each channel cluster of the one or more channel clusters corresponds to a set of downlink channels and uplink channels that have one or more similar transmission characteristics.

3. The apparatus of claim 1, wherein the set of the channel cluster parameters comprises an angle of arrival (AoA) parameter, a zenith angle of arrival (ZoA) parameter, an angle of departure (AoD) parameter, a zenith angle of departure (ZoD) parameter, a delay parameter, an angular spread parameter in azimuth and zenith, or any combination thereof.

4. The apparatus of claim 1, wherein the processing system is configured to cause the UE to:
output a first number of the one or more channel clusters, wherein the first number of the one or more channel clusters is based at least in part on one or more first eigenvectors associated with the one or more downlink reference signal transmissions.

5. The apparatus of claim 4, wherein the processing system is configured to cause the UE to at least one of:
output a first indication that a network entity is to align with the first number of the one or more channel clusters, and a corresponding set of the channel cluster parameters, for each channel cluster of the first number of the one or more channel clusters; or
output a second indication that the network entity is to choose whether to align with the first number of the one or more channel clusters, and a corresponding set of the channel cluster parameters, for each channel cluster of the first number of the one or more channel clusters, or whether to suggest a number of the one or more channel clusters different from the first number.

6. The apparatus of claim 1, wherein the processing system is configured to cause the UE to:
obtain a second number of the one or more channel clusters, wherein the second number of the one or more channel clusters is based at least in part on one or more second eigenvectors associated with the one or more uplink reference signal transmissions.

7. The apparatus of claim 6, wherein the processing system is configured to cause the UE to at least one of:
align with the second number of the one or more channel clusters, and a corresponding set of the channel cluster parameters, for each channel cluster of the second number of the one or more channel clusters; or
select whether to align with the second number of the one or more channel clusters, and a corresponding set of the channel cluster parameters, for each channel cluster of the second number of the one or more channel clusters, or whether to suggest a number of the one or more channel clusters different from the second number.

8. The apparatus of claim 1, wherein the processing system is configured to cause the UE to:
estimate a tap delay value for each channel cluster of the one or more channel clusters;
estimate a complex gain value for each channel cluster of the one or more channel clusters; and
output the tap delay value and the complex gain value for each corresponding channel cluster.

9. The apparatus of claim 1, wherein the same periodicity is defined by a first periodicity value, and wherein the processing system is configured to cause the UE to:
obtain a second periodicity value for the same periodicity of the one or more downlink reference signal transmissions and the one or more uplink reference signal transmissions, wherein the second periodicity value is based at least in part on variance attributes associated with one or more first covariance matrices of one or more downlink channels or one or more second covariance matrices of one or more uplink channels.

10. The apparatus of claim 1, wherein the processing system is configured to cause the UE to:
output channel polarization information, wherein the channel polarization information is estimated based at least in part on the one or more downlink reference signal transmissions.

11. The apparatus of claim 1, wherein the at least one downlink reference signal configuration is associated with a first bandwidth part (BWP) and the at least one uplink reference signal configuration is associated with a second BWP different from the first BWP.

12. The apparatus of claim 1, wherein:
the reference signal configuration comprises a first time duration that is shorter than a second time duration,
the first time duration is between a first downlink reference signal transmission of the one or more downlink reference signal transmissions and a corresponding first uplink reference signal transmission of the one or more uplink reference signal transmissions within a periodicity of the one or more downlink reference signal transmissions, and
the second time duration is the periodicity of the one or more downlink reference signal transmissions.

13. The apparatus of claim 1, wherein the reference signal configuration is associated with a frequency division duplex (FDD) communication scheme.

14. The apparatus of claim 13, wherein the processing system is configured to cause the UE to:
output a physical uplink shared channel (PUSCH) transmission in accordance with the FDD communication scheme based at least in part on a corresponding set of the channel cluster parameters for a first channel cluster of the one or more channel clusters.

15. A method for wireless communications by a user equipment (UE), the method comprising:
obtaining a reference signal configuration, wherein:
the reference signal configuration comprises at least one downlink reference signal configuration and at least one uplink reference signal configuration, and
one or more downlink reference signal transmissions associated with the at least one downlink reference signal configuration have a same periodicity as one or more uplink reference signal transmissions associated with the at least one uplink reference signal configuration; and
outputting, for each channel cluster of one or more channel clusters, a set of channel cluster parameters, wherein the set of the channel cluster parameters are based at least in part on the one or more downlink reference signal transmissions.

16. The method of claim 15, wherein each channel cluster of the one or more channel clusters corresponds to a set of downlink channels and uplink channels that have one or more similar transmission characteristics.

17. The method of claim 15, wherein the set of the channel cluster parameters comprises an angle of arrival (AoA) parameter, a zenith angle of arrival (ZoA) parameter, an angle of departure (AoD) parameter, a zenith angle of departure (ZoD) parameter, a delay parameter, an angular spread parameter in azimuth and zenith, or any combination thereof.

18. The method of claim 15, further comprising:
outputting a first number of the one or more channel clusters, wherein the first number of the one or more channel clusters is based at least in part on one or more first eigenvectors associated with the one or more downlink reference signal transmissions.

19. The method of claim 18, further comprising at least one of:
outputting a first indication that a network entity is to align with the first number of the one or more channel clusters, and a corresponding set of the channel cluster parameters, for each channel cluster of the first number of the one or more channel clusters; or
outputting a second indication that the network entity is to choose whether to align with the first number of the one or more channel clusters, and a corresponding set of the channel cluster parameters, for each channel cluster of the first number of the one or more channel clusters, or whether to suggest a number of the one or more channel clusters different from the first number.

20. One or more non-transitory computer-readable media comprising executable instructions that, when executed by one or more processors of a user equipment (UE), cause the UE to perform operations comprising:
obtaining a reference signal configuration, wherein:
the reference signal configuration comprises at least one downlink reference signal configuration and at least one uplink reference signal configuration, and
one or more downlink reference signal transmissions associated with the at least one downlink reference signal configuration have a same periodicity as one or more uplink reference signal transmissions associated with the at least one uplink reference signal configuration; and
outputting, for each channel cluster of one or more channel clusters, a set of channel cluster parameters, wherein the set of the channel cluster parameters are based at least in part on the one or more downlink reference signal transmissions.
